(19) United States
(12) Patent Application Publication
(10) Pub. No.: US 2004/0111333 A1
(43) Pub. Date: Jun. 10, 2004

(54) Network-based golf club selection system and method of the same

(75) Inventors: Kwan Hang Kang, Gunpo-si (KR); Taki Yoshiro, Osaka (JP)

Correspondence Address: Ladas & Parry, 26 West 61st Street, New York, NY, 10023, US

(73) Assignees: GOLF SYSTEM CO., LTD.; SAMSUNG EVERLAND INC.

(21) Appl. No.: 10/725,722

(22) Filed: Dec. 2, 2003

(30) Foreign Application Priority Data
Dec. 9, 2002 (KR) 10-2002-0077713

(51) Int. Cl. G06F 17/60

(52) U.S. Cl. 705/26

(57) ABSTRACT

The present invention relates to a network-based golf club selection system and a method of the same. There is provided a server computer in which a certain form data is outputted for inputting a basic information data used for computing the optimum CPM in accordance with a request of the user computer connected through the communication network, and when the basic information data such as age, tall, weight, grasping power, career, flying distance by the clubs, swing speed, etc. are inputted from the user computer, the optimum CPM (loft angle of head, lie angle, face angle, head volume, kick point of shaft, etc.) of a corresponding user is computed based on the CPM data with respect to the previously stored basic information, and the product lists by the brands proper to the optimum CPM of a corresponding user is extracted based on the previously stored product lists by the brands and is outputted to a corresponding user computer, and when a purchase data (golf club fabrication data, shaft change data, etc.) of the specific golf club is inputted from the user computer, a cost payment is requested based on the golf club purchase, and the cost payment is performed based on the cost payment data inputted from the user computer, and a delivery of the golf club to the address that the user inputted is controlled.

### BACKGROUND OF THE INVENTION

1. Field of the Invention

The present invention relates to a golf club selection system and a method of the same, and in particular to a network-based golf club selection system and a method of the same which are capable of computing an optimum CPM (Cycle Per Minute) proper to a corresponding user based on various basic information data inputted by users online and providing a brand-based product list based on the computed optimum CPM, so that a user can purchase or exchange an optimum golf club.

2. Description of the Background Art

Generally, the Internet is an open type network by which anyone who wants to connect with a computer of an opponent user can freely connect anywhere using a common protocol called as TCP/IP (Transmission Control Protocol/Internet Protocol). Basic text information can be transferred, and as a data compression technique is advanced, the Internet has been extensively used for transferring multimedia data. In addition, various services including an electronic mail, file transfer, WWW (World Wide Web) service, etc.

As the use of the Internet has been extensively increased all over the world including Korea, the Internet is recognized as an important strategic tool for enhancing an efficiency and productivity throughout the conventional industry field. An Internet-based new business has been continuously created. The field of the businesses is expanded. The number of the business people who use the Internet is also increased.

Namely, as one type of the Internet-based business, there are Internet advertisement, Internet broadcasting, online game, Internet newspaper/magazine, data search service, portal service, electronic commerce, etc. The Internet sites providing the above services are increasing.

Among the above Internet sites, as the electronic commerce is increased, the Internet sites that are designed to sale various products and information are significantly increased. In particular, the Internet sites providing a golf club sale service, golf information providing service, etc. are also significantly increased based on the increase of golf users.

However, almost Internet sites providing the above golf related services are designed to simply provide brand-based product information for selling golf clubs, golf common knowledge, country club information, etc., but are not designed to provide services on whether a corresponding user uses a golf club proper to the user based on a user's physical condition, swing, the current golf club.

Namely, the golf club is made of different materials and has different characteristics by the brand (for example, whether the material of shaft is soft or hard, and balance state and weight and length as well as flexibility and CPM (Cycle Per Minute) are important). Since the user's swing habit or condition are different, it is needed to buy an optimum golf club based on a user's physical condition, career, swing speed, etc. in order to increase a flying distance and achieve an accurate shot. In addition, it is needed to adjust the current golf club.

In order to overcome the above problem, the user is needed to buy a golf club proper to the user or is needed to directly visit an offline shop having a program or measuring apparatus capable of measuring a swing speed, flexibility, CPM, etc. for adjusting the current golf club for thereby measuring a user's physical condition, swing speed, CPM, etc. The user buys an optimum golf club or adjusts the current golf club based on the measured data for thereby generating much inconveniences.

### SUMMARY OF THE INVENTION

Accordingly, it is an object of the present invention to provide a network-based golf club selection system and a method of the same capable of overcoming the problems encountered in the conventional art and to provide a network-based golf club selection system and a method of the same capable of computing an optimum CPM (Cycle Per Minute) proper to a corresponding user based on a basic information data such as an age, tall, grasping power, career, flying distance by the club, swing speed, etc. inputted by the user online and providing a brand-based product list proper to the computed optimum CPM for thereby selecting and buying an optimum golf club on the electronic commerce and exchanging the golf club between the users.

It is another object of the present invention to provide a network-based golf club selection system and a method of the same capable of computing an accurate and reliable optimum CPM (Cycle Per Minute) by providing different weights with respect to a basic information item by considering a relationship between each basic information item and optimum CPM in the case that the optimum CPM is computed based on various basic information data inputted by the users.

To achieve the above objects, there is provided a network-based golf club selection system, comprising a communication network capable of connecting a plurality of communication lines of users and performing a data communication related to a golf club selection between the users; a plurality of user computers in which a communication is connected with a server computer through the communication network in accordance with a control the user, and a basic information data used for computing an optimum CPM (Cycle Per Minute) such as age, tall, weight, grasping power, career, flying distance by the cubs, swing speed, etc. inputted by the user in accordance with a form data provided from the server computer is outputted to the server computer, and when the product lists by the brands proper to the optimum CPM of a corresponding user are inputted from the server computer, a purchase data and cost payment data of a specific golf club selected by the user who requested the product lists by the brands are outputted to the server computer; and a server computer in which a certain form data is outputted for inputting a basic information data used for computing the optimum CPM in accordance with a request of the user computer connected through the communication network, and when the basic information data such as age, tall, weight, grasping power, career, flying distance by the clubs, swing speed, etc. are inputted from the user computer, the optimum CPM (loft angle of head, lie angle, face angle, head volume, kick point of shaft, etc.) of a corresponding user is computed based on the CPM data with respect to the previously stored basic information, and the product lists by the brands proper to the optimum CPM of a corresponding user is extracted based on the previously stored product lists by the brands and is outputted to a corresponding user computer, and when a purchase data (golf club fabrication data, shaft change data, etc.) of the specific golf club is inputted from the user computer, a cost payment is requested based on the golf club purchase, and the cost payment is performed based on the cost payment data inputted from the user computer, and a delivery of the golf club to the address that the user inputted is controlled.

To achieve the above objects, there is provided a network-based golf club selection method, comprising the steps of (1) a step in which a member connection of a user computer that connected with a server computer through a communication network is performed, and a certain form data is outputted to a corresponding user computer for inputting a basic information data used for computing the optimum CPM (Cycle Per Minute) in accordance with an optimum CPM computation request of the user computer; (2) a step in which when a basic information data such as age, tall, weight, grasping power, career, flying distance by the clubs, swing speed, etc. is inputted from the user computer, the server computer provides different weights by the basic information items in accordance with a correlation between each basic information item and the optimum CPM based on the CPM data with respect to each previously stored basic information and computes the optimum CPM of a corresponding user; (3) a step in which the server computer extracts, from the golf club database, a product list by the brands proper to the optimum CPM of a corresponding user computed based on the basic information data inputted from the user computer and outputs to a corresponding computer; and (4) a step in which when a purchase data of a specific golf club is inputted from the user computer that received the product list by the brands proper to the optimum CPM, the server computer requests a cost payment and performs the cost payment based on the golf club purchase based on the cost payment data inputted from the user computer and controls an operation that the golf club is delivered to the address that a corresponding user inputted.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram illustrating the construction of a network-based golf club selection system according to the present invention;

FIG. 2 is a block diagram illustrating the construction of a server computer of FIG. 1;

FIG. 3 is a graph illustrating a CPM (Cycle Per Minute) of each golf club computed based on a basic information data inputted by a user;

FIG. 4 is a flow chart of an operation procedure of a network-based golf club selection method according to the present invention; and

FIGS. 5 through 8 are flow charts of an operation procedure of each subroutine of FIG. 4.

### DETAILED DESCRIPTION OF THE PREFERRED EMBODIMENTS

The network-based golf club selection system and a method of the same according to the present invention will be described with reference to the accompanying drawings.

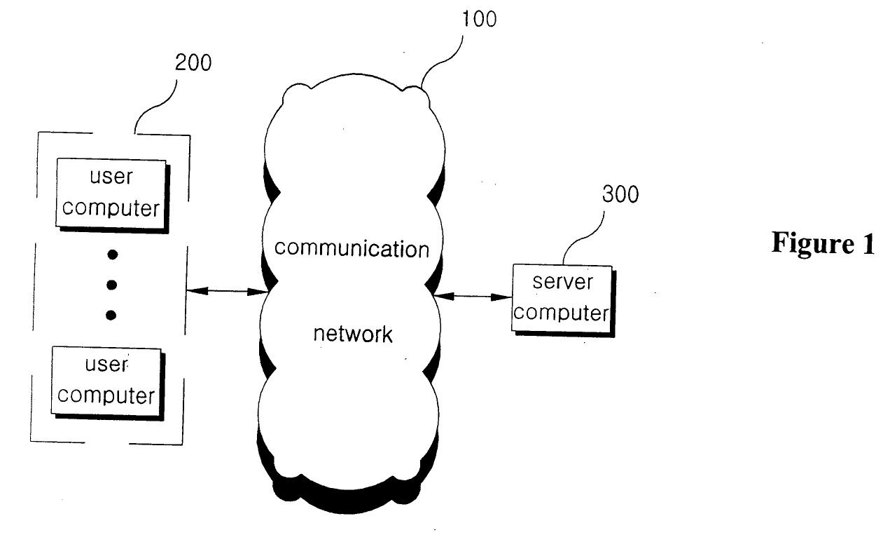

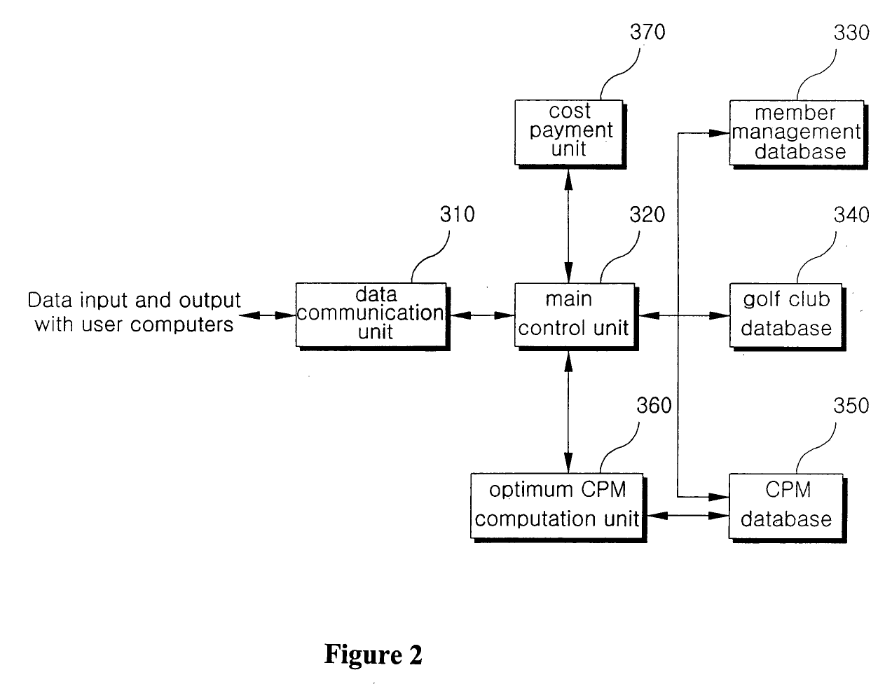

FIG. 1 is a block diagram illustrating the construction of a network-based golf club selection system according to the present invention, and FIG. 2 is a block diagram illustrating the construction of a server computer of FIG. 1.

As shown therein, a communication network 100 is a communication network such as a wired/wireless Internet, etc., and a communication line is connected between a plurality of user computers 200 and a server computer 300. A data communication on a golf club selection is performed between the user computers 200 and the server computer 300.

The user computers 200 are connected with the server computer 300 through the communication network 100 based on a user's operation. An optimum CPM computation request data of a user who performed a communication connection is outputted to the server computer 300. The user computers 200 receive a form data from the server computer 300, in which the basic information data can be inputted for an optimum CPM computation.

In addition, the user computers 200 output the basic information data for computing the optimum CPM such as age, tall, weight, grasping power, flying distance by the club, swing speed, etc. (including sex, golf record, number of play rounds, number of practices, handicap, etc.) inputted by the user based on the form data provided by the server computer 300 to the server computer. When the user computers 200 receive the product lists by the brands proper to the optimum CPM of a corresponding user, the purchase data of a specific golf club selected by the user who wants the product lists by the brands is outputted to the server computer 300.

At this time, the product lists by the brands inputted from the server computer 300 capable of computing an optimum CPM of a corresponding user include detailed information of a corresponding golf club (for example, flexibility, length, weight, characteristic, etc.) and price information.

The server computer 300 outputs a certain form data to a corresponding user computer 200, so that the user is connected with the server computer 300 through the communication network 100 and inputs a basic information data for computing the optimum CPM based on the request of the user computer 200. When the basic information data such as age, tall, weight, grasping force, career, flying distance by the club, swing speed, etc. are inputted from the user computer 200, the optimum CPM (characteristics of loaf angle of head, lie angle, face angle, volume of head, kick point of shaft, etc., and weight of the entire club, etc.) of a corresponding user is computed based on the CPM data with respect to each basic information previously stored.

In addition, in the server computer 300, the product lists by the brands proper to the optimum CPM of a corresponding user are extracted based on the products lists by each brand previously stored. The extracted products lists are outputted to a corresponding user computer 200. When the purchase data (specific golf club fabrication data, specific shaft change data, etc.) of a certain golf club are inputted from the user computer 200 that received the product lists by the brand proper to the optimum CPM, a cost payment is requested. The cost payment of the golf club that will be purchased based on the cost payment data inputted from the user computer 200 is performed, and the golf club is delivered to the address that the user inputted.

At this time, the server computer 300 includes a data communication unit 310, a main control unit 320, a member management database 330, a golf club database 340, a CPM database 350, an optimum CPM computation unit 360 and a cost payment unit 370.

The data communication unit 310 is designed to process a data input for a member connection or new member registration with the user computer 200 connected through the communication network 100 in accordance with a control of the main control unit 320, an output of a form data for inputting a basic information data for computing the optimum CPM, an input of a basic information data such as age, tall, weight, grasping power, career, flying distance by the clubs, swing speed, etc. based on the form data, an output of the product list by the brands proper to the optimum CPM of a corresponding user, and an input of the purchase data of a specific golf club and a data of a cost payment.

The main control unit 320 controls an operation that a form data is outputted for inputting a basic information data for computing the optimum CPM based on a form data request of the specific user computer 200 inputted through the data communication unit 310. The main control unit 320 controls an operation that the optimum CPM of a corresponding user is computed from the optimum CPM computation unit 360 based on the basic information data such as age, tall, weight, grasping power, career, flying distance by the clubs, swing speed, etc. inputted through the data communication unit 310. The main control unit 320 controls an operation that the product lists by the brands proper to the optimum CPM of a corresponding user are extracted and outputted to the user computer 200 based on the golf club database 340. The main control unit 320 controls an operation that the cost payment is processed by the cost payment unit 370 with respect to the golf club purchase based on the purchase data and cost payment data of a specific golf club inputted through the data communication unit 310. The main control unit 320 controls an operation that the golf club purchased by the user is delivered to the address that the user inputted.

The member management database 330 stores a log-in information and personal information of each user, and basic information data such as age, tall, weight, grasping power, career, flying distance by the clubs, swing speed, etc. for setting the optimum CPM, and an optimum CPM computed through the optimum CPM computation unit 360 in accordance with a control of the main control unit 320.

The golf club database 340 stores the product lists by each brand being sold on the electronic commerce in accordance with a control of the main control unit 320.

The CPM database 350 stores the CPM information of the standard with respect to each basic information such as age, tall, weight, grasping power, flying distance by the clubs, swing speed, etc. in accordance with a control of the main controller 320.

The optimum CPM computation unit 360 computes the optimum CPM of a corresponding user using the CPM database 350 having the CPM information of the standard with respect to basic information based on the basic information data inputted from the user computer 200 in accordance with a control of the main control unit 320.

The cost payment 370 performs a cost payment based on the purchase of a corresponding golf club based on the cost payment data inputted from the user computer 200 that performed the purchase of a specific golf club in accordance with a control of the main control unit 320.

The sever computer 300 generates a diagnosis data of a golf club proper to a corresponding user in accordance with the optimum CPM of a corresponding user computed based on various basic information data inputted by the user. The generated diagnosis data are outputted to a corresponding user computer 200 together with the product lists by the brands proper to the optimum CPM of a corresponding user, so that the users review the same.

When computing the optimum CPM of a corresponding user using the CPM information standardized by each basic information item based on various basic information data inputted by the users, the server computer 300computes the optimum CPM of a corresponding user by providing different weights with respect to the basic information items in consideration with a relationship between each basic information item and the optimum CPM.

The above described CPM corresponds to the values with respect to the cycle movements for one minute concerning whether a golf shaft that is actually being swung has a certain degree of flexibility, and the optimum CPM corresponds to the values of the golf club shaft most proper to each personal swing. The server computer 300 computes the optimum CPM of each user using the weights by the basic information item provided in consideration with the relationship between the CPM information and each basic information item and the optimum CPM standardized by the basic information data such as age, tall, weight, grasping power, career, flying distance by the clubs, swing speed, etc. of each user.

For example, in the case that the weight of the user is W, the optimum CPM F (W) with respect to the weight of a corresponding user is computed based on the following equation.

F(W)=αW+β(α,β represents integer number)

Namely, it is possible to compute a relationship of the CPM with respect to each basic information inputted by the user based on the CPM data with respect to each basic information stored in the CPM database 350.

After the relationship of the CPM with respect to each basic information inputted by the user is computed, the server computer 300 provides a weight by each basic information item inputted by the user by considering a correlation between each basic information item and the optimum CPM (for example, the correlation between the weight and the optimum CPM may be weak, but the correlation between the handicap and the optimum CPM is strong) and computes the optimum CPM of a corresponding user using the weight by each basic information item.

Assuming that the optimum CPM of a corresponding user using basic information items W, X and Y inputted by the user, after F (W), F (X) and F (Y) are computed, in the present invention, the server computer 300 does not divide the summed value of F (W)+F (X)+F (Y) by 3 that is the number of the basic information item inputted by the user. Namely, the server computer 300 computes the optimum CPM of a corresponding user based on the following equation using the weights (for example, the item W is 0.5, the item X is 0.2 and the item Y is 0.3) provided to three basic information items.

Optimum CPM=aF(W)+bF (X)+cF (Y)

Therefore, in the server computer 300, it is possible to automatically correct and select the optimum CPM with respect to all clubs based on the previously stored characteristics of each club even when the user inputs only the flying distance with respect to one club.

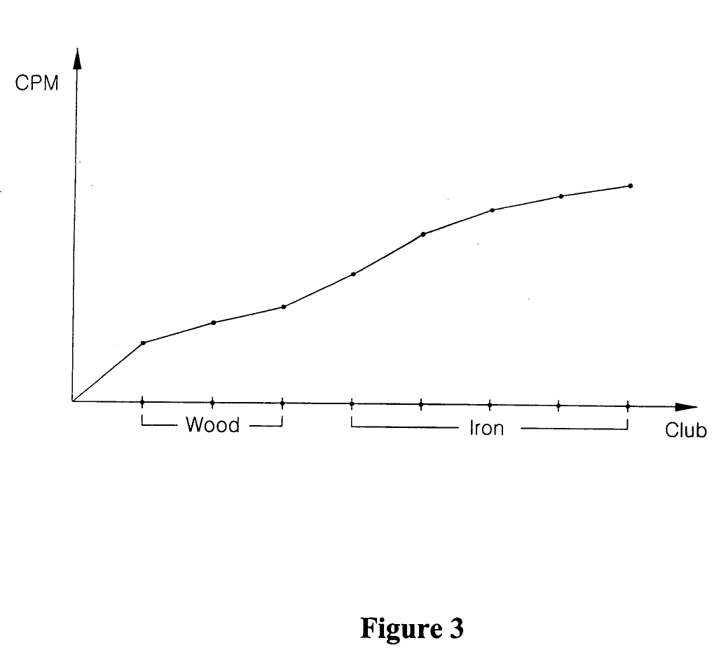

Assuming that the club number is a horizontal axis, and the club CPM is a vertical axis, the optimum CPM with respect to each club may be expressed as a straight line (proportional) (as shown in FIG. 3). When a certain golf club having the CPM in a range matched with the above line or similar with the line is selected, it is considered that the optimum golf club is selected for thereby being most proper to the user. In addition, if the user corrects the range to be on the line indicating the optimum CPM or exchanges the product, it is possible to adjust the current golf club to the golf club more proper to the user's swing characteristic.

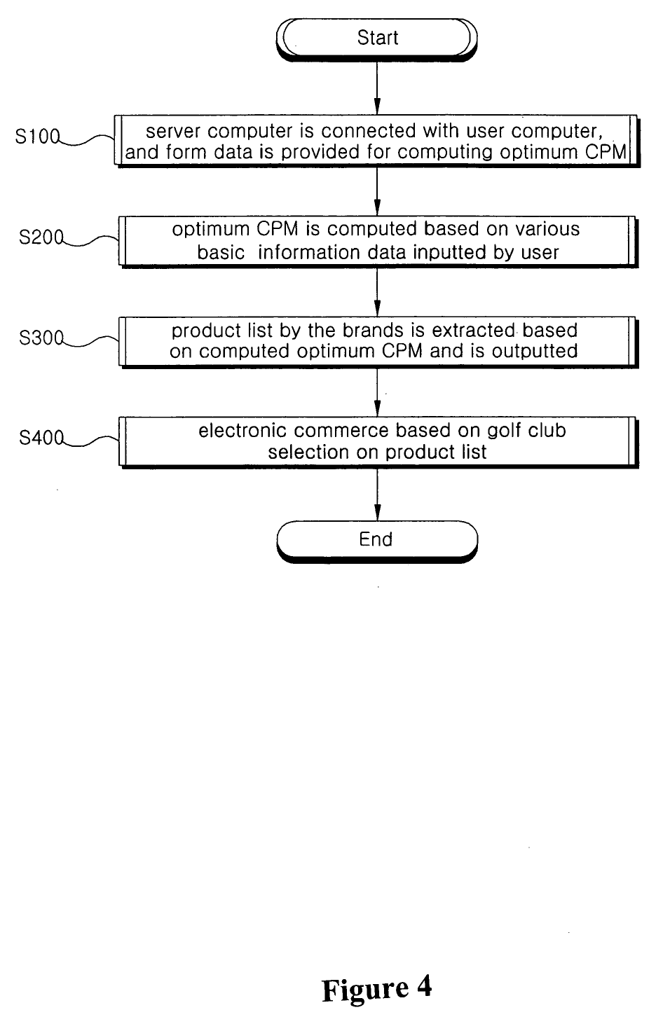

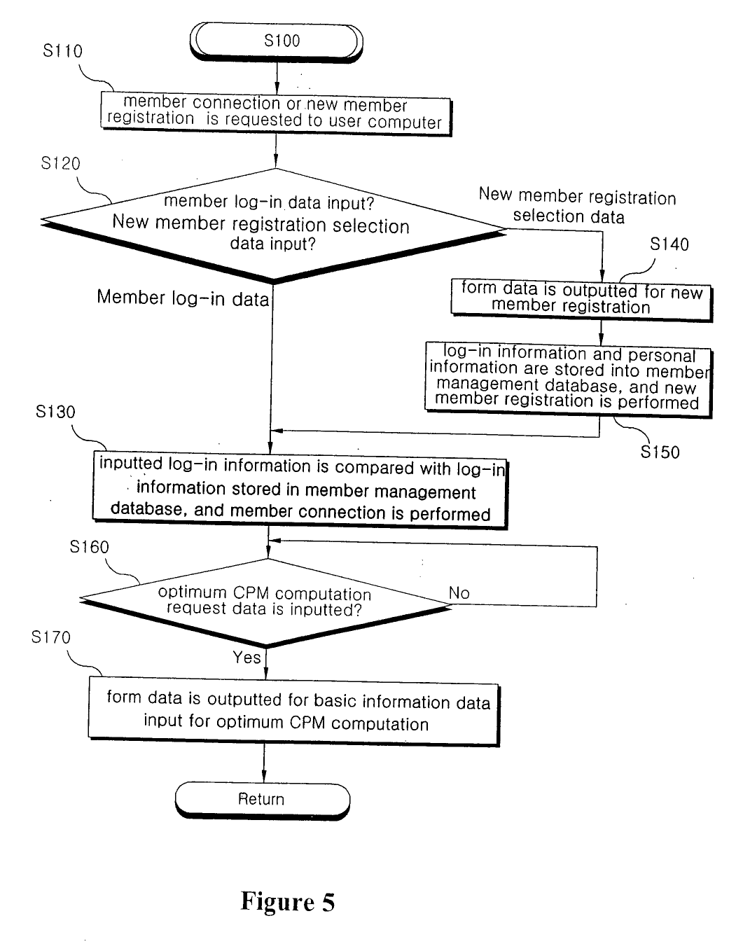

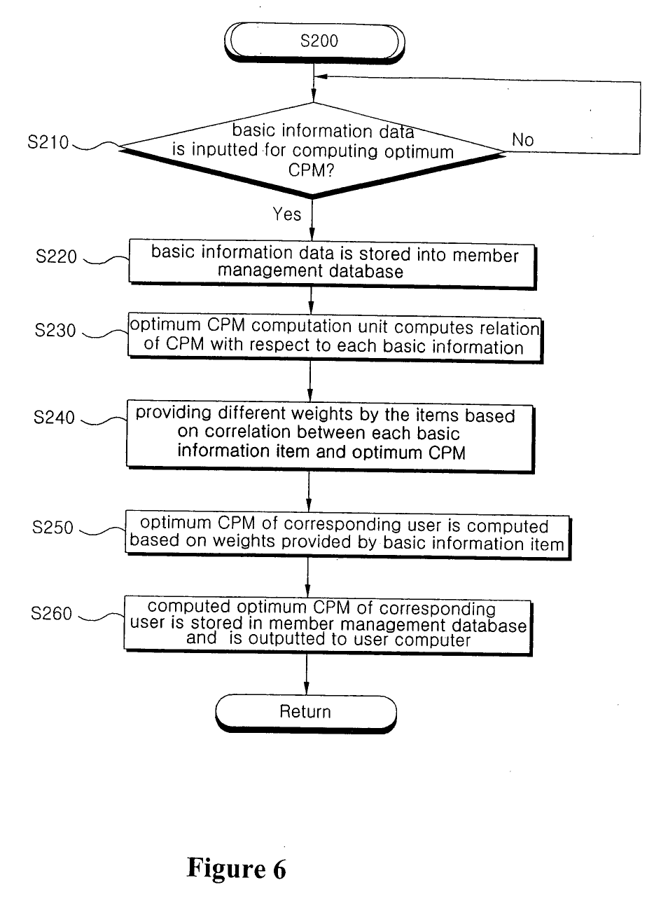

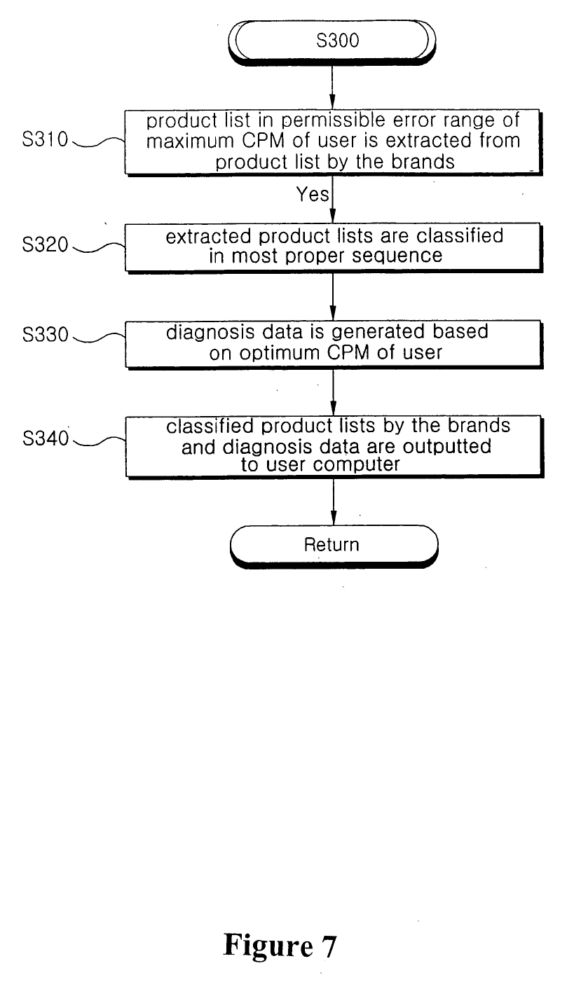

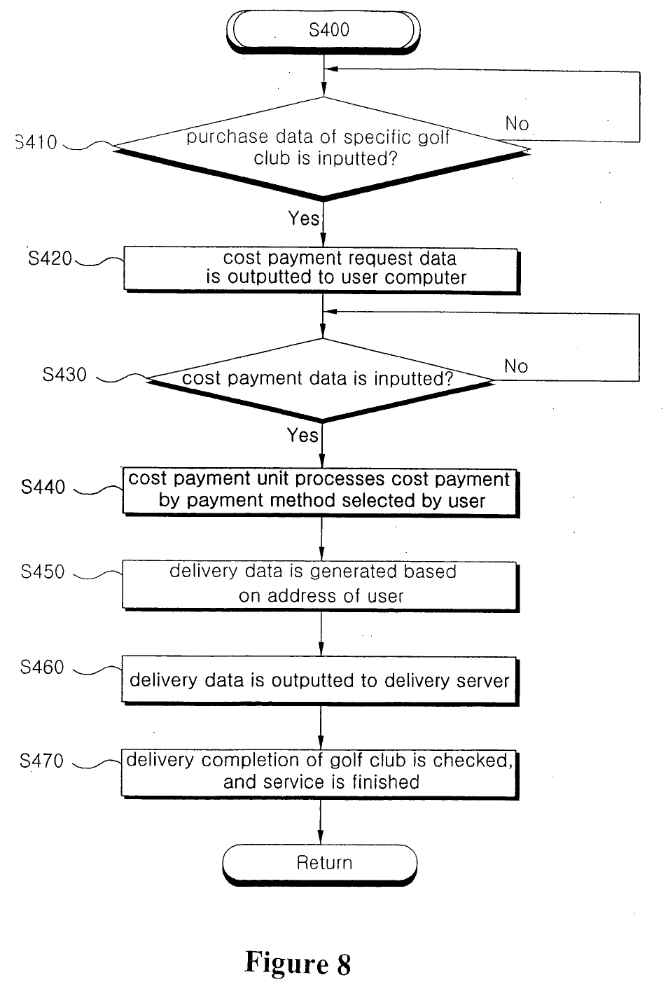

Next, the network-based golf selection method according to the present invention will be described with reference to FIGS. 4 through 8.

FIGS. 4 through 8 are flow charts illustrating an operation procedure of a network-based golf club selection method according to the present invention.

First, the server computer 300 performs a member connection of the user computer 200 connected with the server computer 300 through the communication network 100 and outputs a certain form data to the user computer 200 for thereby inputting a basic information data for computing the optimum CPM in accordance with a request of the user computer 200 (S100).

Namely, the server computer 300 requests a member log-in or new member registration to the user computer 200 connected with the server computer 300 through the communication network 100 (S110), and the server computer 300 judges whether the member log-in data is inputted or not from the user computer 200, or whether the new member registration selection data is inputted or not (S120).

As a result of the judgment, when the member login data is inputted from the user computer 200, the server computer 300 compares the inputted data with a login data of a corresponding user stored in the member management database 330 and performs a member connection (S130).

As a result of the judgment S120, when a new member registration selection data is inputted from the user computer 200, the server computer 300 outputs a certain form data used for a new member registration to the user computer 200 (S140). The server computer 300 stores the login information and personal information inputted by the user using the form data into the member management database 330 and requests a reconnection to the user computer 200 (S150).

After the member connection is performed, the server computer 300 judges whether an optimum CPM computation request data is inputted from the user computer 200 connected with the sever computer 300 (S160). As a result of the judgment, when the optimum CPM computation request data is inputted from the user computer 200, a certain form data for inputting a basic information data for the optimum CPM computation is outputted to the user computer 200 (S170).

After the user computer 200 is connected with the server computer 300 in the above step S100, and the form data for inputting a basic information data for the optimum CPM computation is provided, when the basic information data such as age, tall, weight, grasping power, career, flying distance by the clubs, swing speed, etc. are inputted from the user computer 200, the server computer 300 provides different weights by the basic information items in accordance with the correlation between each basic information and the optimum CPM based on the CPM data with respect to each basic information previously stored and computes the optimum CPM (S200).

Namely, the server computer 300 judges whether a basic information data is inputted from the user computer 200 for computing the optimum CPM (S210). As a result of the judgment, when the basic information data is inputted from the user computer 200 for computing the optimum CPM, the basic information data for computing the optimum CPM inputted from the user computer 200 are stored in the member management database 330 (S220).

The optimum CPM computation unit 360 of the server computer 300 computes a relationship of the CPM with respect to each basic information inputted from the user computer 200 based on the CPM data with respect to each basic information stored in the CPM database 350 (S230).

After the relationship of the CPM with respect to each basic information, the optimum CPM computation unit 360 provides different weights by the basic information items in accordance with a correlation between each basic information item and the optimum CPM (S240) and computes the optimum CPM of a corresponding user based on different weights provided by the basic information items (S250).

Thereafter, the server computer 300 stores the optimum CPM of a corresponding user computed by the optimum CPM computation unit 360 into the member management database 330 and outputs to the user computer 200 that requested the optimum CPM computation, so that the user can check the optimum CPM proper to the user (S260).

After the optimum CPM of a corresponding user is computed by providing different weights by the basic information items inputted by the user in the step S200, the server computer 300 extracts the product lists by the brands proper to the optimum CPM proper to a user computed based on the basic information data inputted from the user computer 200 and outputs to a corresponding user computer 200 (S300).

Namely, the server computer 300 extracts the product lists by the brands in a permissible error range of the optimum CPM of a corresponding user computed in the step S200 among the product lists by the brands stored in the golf club database 340 (S310) and classifies the extracted product lists by the brands most proper to the optimum CPM of a corresponding user (S320).

In addition, the server computer 300 generates a diagnosis data with respect to the golf club proper to a corresponding user based on the optimum CPM of a corresponding user computed in the step S200 (S330).

The server computer 300 outputs the product lists by the brands sequentially classified based on the optimum CPM of a corresponding user in the step S320 and the diagnosis data generated in the step S330 to the user computer 200 (S340).

The product lists by the brands proper to the optimum CPM of a user is provided to the user in the step S300, and the server computer 300 requests a cost payment when the purchase data of a specific golf club is inputted from the user computer 200 that received the product lists by the brands proper to the optimum CPM, and the server computer 300 performs the cost payment based on the golf club purchase based on the cost payment data inputted from the user computer 200 and controls an operation that the golf club is delivered to the address that the user inputted (S400).

Namely, the server computer 300 judges whether the purchase data of a specific golf club is inputted from the user computer 200 that received the product lists by the brands proper to the optimum CPM (S410).

As a result of the judgment, when the purchase data of the golf club is inputted from the user computer 200, the cost payment unit 370 of the server computer 300 outputs a cost payment request data needed for the payment of the golf club selected by the user to the user computer 200 (S420).

In addition, the cost payment unit 370 of the server computer 300 judges whether the cost payment data (payment method, payment amount, etc.) is inputted from the user computer 200 based on the purchase of the golf club (S430).

As a result of the judgment, when the cost payment data is inputted from the user computer 200 based on the purchase of the golf club, the cost payment unit 370 processes the cost payment based on the golf club purchase through the payment method (including all common payment methods including credit card, account transfer, etc.) selected by the user (S440).

After the cost payment is processed through the payment method selected by the user, the server computer 300 generates a delivery data for delivering the golf club purchased by the user to the address that the user inputted (S450) and outputs the generated delivery data to the server (not shown) of a staff who is in charge of the delivery (S460).

In addition, the server computer 300 checks the delivery completion of the golf club purchased by the user and finishes the service (S470).

As described above, in the network-based golf club selection system and a method of the same according to the present invention, it is possible to obtain the optimum CPM proper to a user's swing characteristic by providing a basic information online without directly visiting an offline shop having a program or a measuring apparatus capable of measuring swing speed, flexibility, CPM, etc. for purchasing a golf club proper to the user's swing characteristic or adjusting the same as compared to the conventional art. In addition, it is possible to conveniently purchase or change the golf clubs on the electronic commerce by receiving information concerning the golf clubs by the brands proper to the user's optimum CPM for thereby increasing the flying distance. Stable and accurate shots are possible in the present invention.

In addition, since it is possible to automatically compute the optimum CPM proper to a corresponding user using only basic items provided by the user online, the owner of an offline shop can sell the golf clubs proper to the user using the optimum CPM computed based on each user for thereby maximizing the business profit.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A network-based golf club selection system, comprising:
a communication network capable of connecting a plurality of communication lines of users and performing a data communication related to a golf club selection between the users;
a plurality of user computers in which a communication is connected with a server computer through the communication network in accordance with a control the user, and a basic information data used for computing an optimum CPM (Cycle Per Minute) such as age, tall, weight, grasping power, career, flying distance by the cubs, swing speed, etc. inputted by the user in accordance with a form data provided from the server computer is outputted to the server computer, and when the product lists by the brands proper to the optimum CPM of a corresponding user are inputted from the server computer, a purchase data and cost payment data of a specific golf club selected by the user who requested the product lists by the brands are outputted to the server computer; and
a server computer in which a certain form data is outputted for inputting a basic information data used for computing the optimum CPM in accordance with a request of the user computer connected through the communication network, and when the basic information data such as age, tall, weight, grasping power, career, flying distance by the clubs, swing speed, etc. are inputted from the user computer, the optimum CPM (loft angle of head, lie angle, face angle, head volume, kick point of shaft, etc.) of a corresponding user is computed based on the CPM data with respect to the previously stored basic information, and the product lists by the brands proper to the optimum CPM of a corresponding user is extracted based on the previously stored product lists by the brands and is outputted to a corresponding user computer, and when a purchase data (golf club fabrication data, shaft change data, etc.) of the specific golf club is inputted from the user computer, a cost payment is requested based on the golf club purchase, and the cost payment is performed based on the cost payment data inputted from the user computer, and a delivery of the golf club to the address that the user inputted is controlled.

2. The system of claim 1, wherein said server computer includes:
a data communication unit for processing an output of a form data for inputting a basic information data for an optimum CPM computation with a user computer connected through the communication network, an input of a basic information data such as age, tall, weight, grasping power, career, flying distance by the clubs, swing speed, etc. based on the form data, an output of the product lists by the brands proper to the optimum CPM of a corresponding user, and an input of the purchase data and cost payment data of a specific golf club;
a main controller for controlling an output of the form data for inputting a basic information data for an optimum CPM computation in accordance with a form data request of the user computer inputted through the data communication unit, an optimum CPM computation of a corresponding user based on the basic information data such as age, tall, weight, grasping power, career, flying distance by the clubs, swing speed, etc. inputted through the data communication unit, an extraction of the product lists by the brands proper to the optimum CPM of a corresponding user based on the golf club database and an output to a corresponding user computer, and a process of the cost payment based on the golf club purchase based on the purchase data and cost payment data of the golf club inputted through the data communication unit and a delivering process of the purchased golf club;
a member management database for storing log-in information, personal information, and the basic information data such as age, tall, weight, grasping power, career, flying distance by the clubs, swing speed, etc. used for setting the optimum CPM and the optimum CPM computed by the optimum CPM computation unit in accordance with a control of the main control unit;
a golf club database for storing the product lists by the brands sold through an electronic commerce in accordance with a control of the main control unit;
a CPM database for storing a CPM information of the standard with respect to basic information such as age, tall, weight, grasping power, career, flying distance by the clubs, swing speed, etc. in accordance with a control of the main control unit;
an optimum CPM computation unit for computing an optimum CPM of a corresponding user using the CPM database in which a standard CPM information with respect to each basic information is stored based on the basic information data inputted from a corresponding user computer in accordance with a control of the main control unit; and
a cost payment unit for performing a cost payment based on the purchase of a corresponding golf club based on the cost payment data inputted from the user computer that selected the purchase of a specific golf club in accordance with a control of the main control unit.

3. The system of claim 1, wherein said server computer generates a diagnosis data of a golf club proper to a corresponding user in accordance with the optimum CPM of a corresponding user computed based on various basic information data inputted by the user and outputs the generated diagnosis data to a corresponding user computer together with the product lists by the brands proper to the optimum CPM of a corresponding user.

4. The system of claim 1, wherein said server computer provides different weights by the basic information items in consideration with a correlation between each basic information item and the optimum CPM and computes the optimum CPM of a corresponding user when computing the optimum CPM using the CPM information standardized by each basic information item based on various basic information data inputted by the user.

5. A network-based golf club selection method, comprising the steps of:
(1) a step in which a member connection of a user computer that connected with a server computer through a communication network is performed, and a certain form data is outputted to a corresponding user computer for inputting a basic information data used for computing the optimum CPM (Cycle Per Minute) in accordance with an optimum CPM computation request of the user computer;
(2) a step in which when a basic information data such as age, tall, weight, grasping power, career, flying distance by the clubs, swing speed, etc. is inputted from the user computer, the server computer provides different weights by the basic information items in accordance with a correlation between each basic information item and the optimum CPM based on the CPM data with respect to each previously stored basic information and computes the optimum CPM of a corresponding user;
(3) a step in which the server computer extracts, from the golf club database, a product list by the brands proper to the optimum CPM of a corresponding user computed based on the basic information data inputted from the user computer and outputs to a corresponding computer; and
(4) a step in which when a purchase data of a specific golf club is inputted from the user computer that received the product list by the brands proper to the optimum CPM, the server computer requests a cost payment and performs the cost payment based on the golf club purchase based on the cost payment data inputted from the user computer and controls an operation that the golf club is delivered to the address that a corresponding user inputted.

6. The method of claim 5, wherein said step (1) includes the sub-steps of:
(1-1) a step in which the server computer requests a member log-in or new member registration to the user computer that is connected with the server computer through the communication network;
(1-2) a step in which the server computer judges whether a member log-in data is inputted from the user computer or a new member registration selection data is inputted from the user computer;
(1-3) a step in which as a result of the judgment, when a member log-in data is inputted from the user computer, the inputted data is compared with a log-in data of a corresponding user stored in the member management database, so that a member connection is performed;
(1-4) a step in which as a result of the step 1-2, when a new member registration selection data is inputted from the user computer, the server computer outputs a certain form data for a new member registration to a corresponding user computer;
(1-5) a step for storing a log-in information and personal information inputted by the user in accordance with a certain form data into the member management database, performing a new member registration process and requesting a reconnection;
(1-6) a step in which the server computer judges whether an optimum CPM computation request data is inputted from the user computer that performed the member connection; and
(1-7) a step in which as a result of the judgment, when an optimum CPM computation request data is inputted from the user computer, the server computer outputs a certain form data to a corresponding user computer for inputting a basic information data for an optimum CPM computation.

7. The method of claim 5, wherein said step (2) includes the sub-steps of:
(2-1) a step in which the server computer judges whether a basic information data is inputted from the user computer for computing the optimum CPM;
(2-2) a step in which as a result of the judgment, when a basic information data is inputted from the user computer for computing the optimum CPM, the server computer stores a basic information data for computing the optimum CPM inputted from the user computer into the member management database;
(2-3) a step in which the optimum CPM computation unit of the server computer computes a relationship of the CPM with respect to each basic information inputted from the user computer based on the CPM data with respect to each basic information stored in the CPM database;
(2-4) a step in which after the relationship of the CPM with respect to each basic information is computed, the optimum CPM computation unit of the server computer provides different weights by the basic information items based on a correlation between each basic information item and the optimum CPM;
(2-5) a step in which the optimum CPM computation unit of the server computer computes the optimum CPM of a corresponding user based on different weights by the basic information item provided in the step (2-4);
(2-6) a step in which the server computer stores the optimum CPM of a corresponding user computed by the optimum CPM computation unit and outputs to a corresponding user computer, so that the user can check the optimum CPM proper to the user.

8. The method of claim 5, wherein said step (3) includes the sub-steps of:
(3-1) a step in which the server computer extracts a product list by the brands in a permissible error range of the optimum CPM of a corresponding user computed in the step (2) among the product lists by each brand stored in the golf club database;
(3-2) a step in which the server computer classifies the product lists by the brands extracted in the step (3-1) in a sequence most proper to the optimum CPM of a corresponding user;
(3-3) a step in which the server computer generates a diagnosis data of a golf club proper to a corresponding user based on the optimum CPM of a corresponding user computed in the step (2); and
(3-4) a step in which the server computer outputs the product list by the brands classified in a sequence most proper to the optimum CPM of a corresponding user in the step (3-2) and the diagnosis data generated in the step (3-3) to a corresponding user computer, respectively.

9. The method of claim 5, wherein said step (4) includes the sub-steps of:
(4-1) a step in which the server computer judges whether a purchase data of a specific golf club is inputted from the user computer that received the product list by each brand proper to the optimum CPM;
(4-2) a step in which as a result of the judgment, when a purchase data of the golf club is inputted, the cost payment unit of the server computer outputs a cost payment request data for paying the specific golf club selected by the user to the user computer;
(4-3) a step in which the server computer judges whether a cost payment data is inputted from the user computer based on the purchase of the specific golf club;
(4-4) a step in which as a result of the judgment, when the cost payment data is inputted from the user computer based on the purchase of the specific golf club, the cost payment unit of the server computer processes a payment of the cost through a payment method selected by the user;
(4-5) a step in which the server computer generates a delivery data for delivering the specific golf club selected by the user to the address that the user inputted, after the user pays the cost through the payment method selected by the user;
(4-6) a step in which the server computer outputs the delivery data generated in the step 4-5 to the server that manages the delivery; and
(4-7) a step in which the server computer checks the completion of the delivery of the golf club purchased by the user and finishes the service.
